(19) United States
(12) Patent Application Publication
(10) Pub. No.: US 2013/0256992 A1
(43) Pub. Date: Oct. 3, 2013

(54) BRUSH SEAL SYSTEM WITH ELLIPTICAL CLEARANCE

(71) Applicants: Xiaoqing Zheng, Schenectady, NY (US); Mehmet Demiroglu, Niskayuna, NY (US); Michael Dennis Mack, Ballston Spa, NY (US); Guoqiang Lu, Watervliet, NY (US)

(72) Inventors: Xiaoqing Zheng, Schenectady, NY (US); Mehmet Demiroglu, Niskayuna, NY (US); Michael Dennis Mack, Ballston Spa, NY (US); Guoqiang Lu, Watervliet, NY (US)

(73) Assignee: GENERAL ELECTRIC COMPANY, Schenectady, NY (US)

(21) Appl. No.: 13/430,991

(22) Filed: Mar. 27, 2012

(51) Int. Cl. F16J 15/44

(52) U.S. Cl. 277/355

(57) ABSTRACT

The present application provides for a brush seal system for use about a rotor of a rotary machine. The brush seal system may include a number of brush seal segments, with each of the brush seal segments having a number of bristles, and one or more of the brush seal segments including an elliptical profile so as to vary a clearance between the brush seal segments and the rotor.

### TECHNICAL FIELD

The present application and the resultant patent relate generally to seals for use with rotary machines and more particularly relate to a brush seal system with an elliptical clearance for use with rotary machines such as steam turbines and the like to accommodate rotor vibration by aligning the major axis with the major vibration direction.

### BACKGROUND OF THE INVENTION

Generally described, steam turbines and the like may have a defined steam path that includes a steam inlet, a turbine section, and a steam outlet. Steam leakage, either out of the steam path or into the steam path from an area of higher pressure to an area of lower pressure, may adversely affect the operating efficiency of the steam turbine. For example, steam path leakage in the turbine between a rotating shaft and a circumferentially surrounding turbine casing may lower the efficiency of the steam turbine. Additionally, steam leakage through the rotor ends between an end-packing and the rotor also may significantly reduce the operating efficiency of the steam turbine. Over time, these steam path losses may lead to an overall increase in fuel costs.

To facilitate and minimize leakage, brush seals may be used between rotating and stationary components. A brush seal may be designed to be in a contact with rotor surfaces so as to minimize leakage. The flexibility of the bristles of the brush seal may accommodate rotor run-outs and growth without suffering seal damage. The internal diameter of a brush seal is therefore made with a substantially circular orientation because the bristles thereof are flexible and compliant. Such an approach generally accommodates deformation of both rotating and stationary components from pressure loading and centrifugal force because thermal gradients, thermal expansion, and thermal contraction during various operational stages may be circumferentially uniform. For turbo-machines with heavily loaded journal bearings, however, the relative motion between rotating components and stationary components may be significantly different between the vertical direction and lateral direction. For instance, certain bearings provide much larger damping in the lateral direction than in the vertical direction. As a result, when the turbine goes through critical speeds such as during startup, shutdown, and other types of transient operations, the vertical vibration amplitude may be significantly higher than the lateral vibration amplitude.

Moreover, the number of brush seals allowed to be used may be limited because such brush seals may cause non-uniform heating to the rotor so as to cause rotor instability. One way to allow for more brush seals is to use variable clearance positive pressure packing (“VCPPP”) seal technology and the like. Generally described, VCPPP seal technology retracts the brush seals during startup. Bristles at the segment ends, however, may fall into a gap when the brush seal ring opens up. The brush seal ring also may have a risk of failing to close properly if contaminants and the like accumulate therein.

There is thus a desire therefore for an improved brush seal system for use with steam turbines and other types of rotary machines. Such an improved brush seal system would have less heat input to the rotor and other components during transient operations and the like so as to allow for more brush seal segments to be used therein and, hence, more efficient sealing. Moreover, such an improved brush seal system may have increased efficiency and overall reliability as compared to known brush seal systems.

### SUMMARY OF THE INVENTION

The present application and the resultant patent thus provide for a brush seal system for use about a rotor of a rotary machine. The brush seal system may include a number of brush seal segments, with each of the brush seal segments having a number of bristles and one or more of the brush seal segments including an elliptical profile so as to vary a clearance between the brush seal segments and the rotor.

The present application and the resultant patent further provide for a brush seal system for use about a rotor of a rotary machine. The brush seal system may include a number of brush seal segments, with each of the brush seal segments having a number of bristles, and one or more of the brush seal segments including a variable length elliptical orientation so as to vary a clearance between the brush seal segments and the rotor.

The present application and the resultant patent further provide for a brush seal system for use about a rotor of a rotary machine. The brush seal system may include a number of brush seal segments, with each of the brush seal segments having a number of bristles, and one or more of the brush seal segments including a contoured bristle elliptical orientation so as to vary a clearance between the brush seal segments and the rotor.

These and other features and improvements of the present application and the resultant patent will become apparent to one of ordinary skill in the art upon review of the following detailed description when taken in conjunction with the several drawings and the appended claims.

### BRIEF DESCRIPTION OF THE DRAWINGS

FIG. 1 is a schematic diagram of an example of a portion of a steam turbine.

FIG. 2 is a schematic diagram of an example of a brush seal system as may be used with the stream turbine of FIG. 1.

FIG. 3 is a schematic diagram of an example of a brush seal system as may be described herein.

FIG. 4 is a schematic diagram of an example of an alternative embodiment of a brush seal system as may be described herein.

FIG. 5 is a plan view of a portion of the brush seal system of FIG. 4.

### DETAILED DESCRIPTION

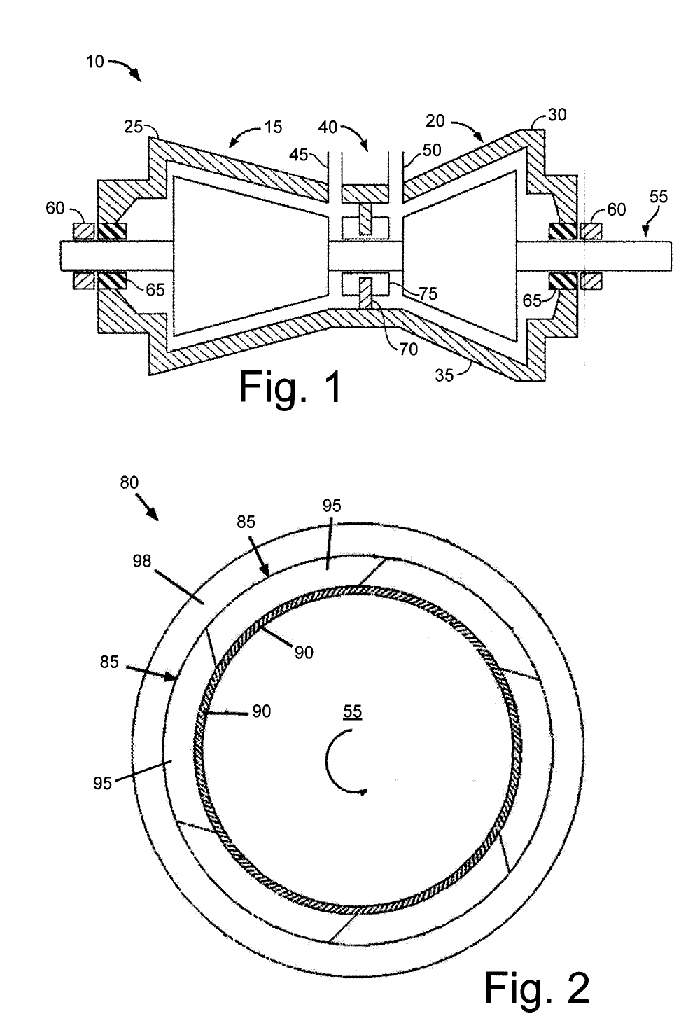

Referring now to the drawings, in which like numerals refer to like elements throughout the several views, FIG. 1 shows a schematic diagram of an example of a steam turbine 10. Generally described, the steam turbine 10 may include a high pressure section 15 and an intermediate pressure section 20. Other pressures and other sections also may be used herein. An outer shell or casing 25 may be divided axially into an upper half section and a lower half section 30, 35, respectively. A central section 40 of the casing 25 may include a high pressure steam inlet 45 and an intermediate pressure steam inlet 50. Within the casing 25, the high pressure section 15 and the intermediate pressure section 20 may be arranged about a rotor 55. The rotor 55 may be supported by a number of bearings 60. A steam seal unit 65 may be located inboard of each of the bearings 60. An annular section divider 70 may extend radially inward from the central section 40 towards the rotor 55. The divider 70 may be received a packing casing 75. Other components and other configurations may be used herein.

During operation, the high pressure steam inlet 45 receives high pressure/high temperature steam from a steam source. The steam may be routed through the high pressure section 15 such that work is extracted from the steam by rotation of the rotor 55. The steam exits the high pressure section 15 and then may be returned to the steam source for reheating. The reheated steam then may be routed to the intermediate pressure steam inlet 50. The steam may be returned to the intermediate pressure section 20 at a reduced pressure as compared to the steam entering the high pressure section 15 but at a temperature that is approximately equal to the temperature of the steam entering the high pressure section 15. Accordingly, an operating pressure within the high pressure section 15 may be higher than an operating pressure within the intermediate pressure section 20 such that steam within the high pressure section 15 tends to flow towards the intermediate pressure section 20 through leakage paths that may develop between the high pressure section 15 and the intermediate pressure section 20. One such leakage path may extend through the packing casing 75 about the rotor shaft 55. Other leaks may develop across the steam seal units 65 and elsewhere.

In order to limit the leakage flow, a brush seal system 80 may be used with the steam turbine 10. The brush seal system 80 may include a number of brush seal segments 85. Each brush seal segment 85 may include a number of bristles 90 attached to a carrier 95. The carrier 95 may be attached to a stationary member 98 such as the packing casing 75 and the like. The bristles 90 may extend towards the rotor 55 or other type of rotating component for contact therewith. As described above, the brush seal system 80 may cause non-uniform heating to the rotor 55 so as to create instability during transient operations and the like. The non-uniform heating may be started with an eccentricity of the rotor 55. Such may cause the rotor 55 to bow in the direction where the rotor 55 receives most heating. In turn, the bowed rotor 55 may press further into the brush seal segment 85 so as to result in more non-uniform heating. Such a self-feeding process may eventually lead to rotor instability.

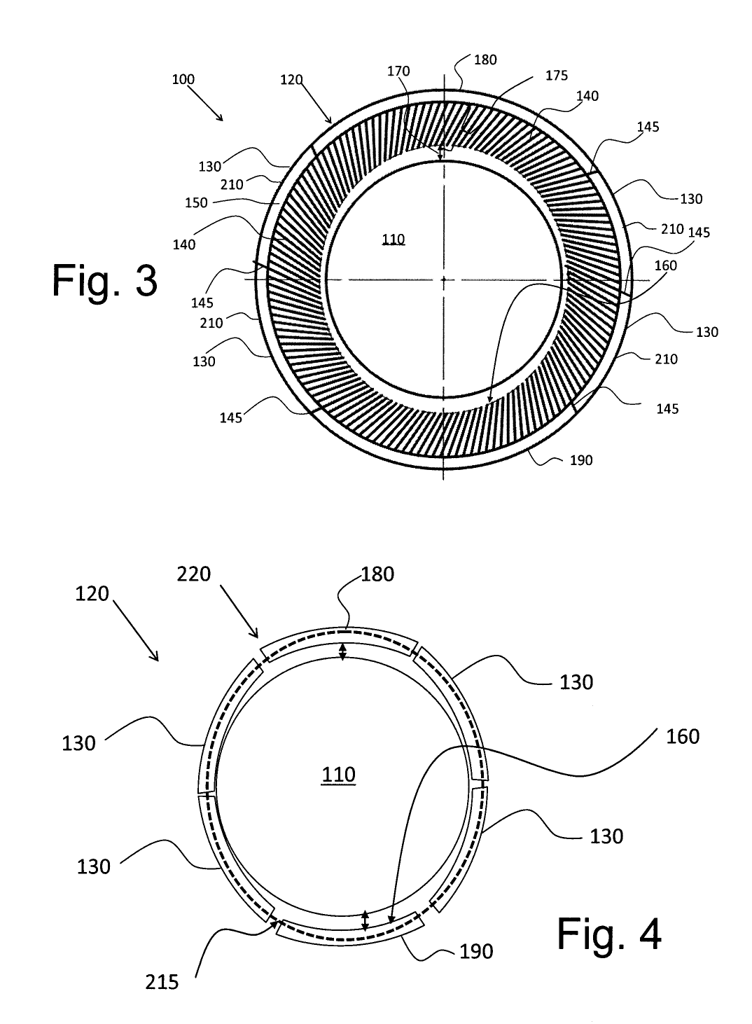

FIG. 3 shows a portion of a rotary machine 100 as may be described herein. The rotary machine 100 may be a steam turbine and the like. The rotary machine 100 may include a rotor 110 or other type of rotating component similar to that described above. The rotary machine 100 also may include a brush seal system 120 that may include a number of brush seal segments 130. As above, the brush seal segments 130 may include a number of bristles 140 attached to a carrier 150. Any number of the brush seal segments 130 may be used herein with any number of bristles 140. Each of the brush seal segments 130 have a pair of segment ends 145. Other components and other configurations may be used herein.

The bristle tips of the brush seal system 120 also may form a substantially elliptical profile 160 with respect to the rotor 110. In case of a vertical critical speed mode when the main rotor vibration is in the vertical direction, the elliptical profile 160 therefore may be oriented with the major axis pointing in the vertical direction. By the elliptical profile 160, the brush seal segments 130 may have less of a clearance 170 about the rotor 110 at the three (3) o'clock and the nine (9) o'clock positions as compared to the twelve (12) o'clock and the six 6 o'clock positions and even less clearance at about the two (2) o'clock, the five (5) o'clock, the seven (7) o'clock, and the ten (10) o'clock positions as is shown. By using the term “elliptical,” we also include various types of hyperboloid, paraboloid, and similar types of shapes and configurations. If the vibration direction is tilted from the vertical direction, the elliptical clearance orientation should have the major axis tilted accordingly.

The elliptical profile 160 may be obtained in a number of different ways. As is shown in FIG. 3, the elliptical profile 160 may have a variable bristle length orientation 175. In the variable bristle length orientation 175, the bristles 140 of a top segment 180 and/or a bottom segment 190 may have a shorter length as compared to the bristles 140 on a number of side segments 210. Bristles 140 of varying lengths may be used herein. Other components and other configurations may be used herein.

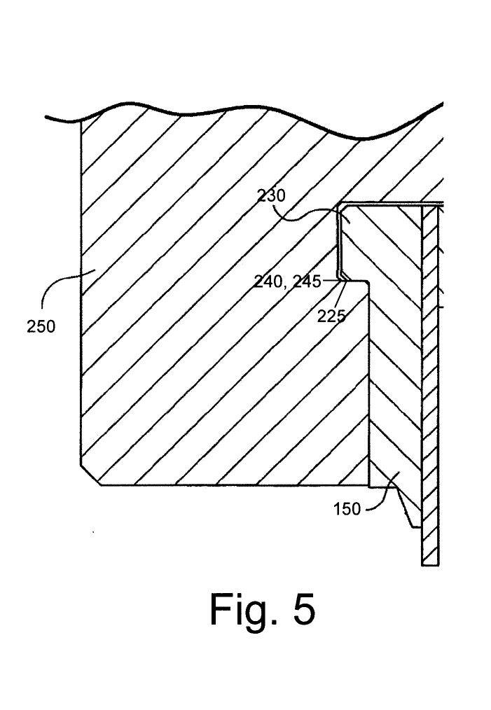

Alternatively as is shown in FIGS. 4 and 5, the elliptical profile 160 may have a contoured orientation 215 that offsets segments to a variable diameter 225 on a brush seal hook 230 of the brush seal carrier 150. In the contoured orientation 215 herein, an elliptical shape 220 may be machined or otherwise formed into the diameter 225 of the brush seal hook 230. In this way, bristle length of the various segments may be similar.

In another example, the elliptical profile 160 may be formed with an elliptical contour on a shoulder 245 of a stationary member 250 to have an offset orientation. In the offset orientation, the hook 230 of the carrier 150 of one or more of the brush seal segments 130 may have an offset diameter 240. As described above, the carrier 150 may be mounted in a stationary member 250 such as a packing casing 75 and the like. The use of the offset diameter 240 thus allows the position of one or more of the brush seal segments 130 to vary with respect to the rotor 110.

Other structures may be used herein so as to promote the elliptical orientation 160. In any of the elliptical profiled 160, the segment ends 145 of adjacent segments 130 may or may not be in contact with each other. Other components and other configurations may be used herein.

The brush seal system 120 thus provides the elliptical profile 160 so as to have a larger clearance 170 along the top segment 180 and the bottom segment 190 as opposed to the side segments 210. The elliptical profile 160 thus may accommodate applicable rotor dynamics that have larger vibrating amplitude in the vertical direction than in the horizontal direction. The larger clearance resulting from the elliptical profile 160 allows more rotor vibration vertically without excessively deflecting the bristle pack and generating destabilizing heat. In such a way, more brush seal systems 120 may be used. The use of more brush seal systems 120 should improve overall efficiency without adding significant heating to the rotor in the major axis direction of the elliptical profile. The leakage penalty herein may be small because of the blown-down effect under operating pressures once the turbine reaches operating speeds. Moreover, the brush seal system 120 described herein may be cheaper and more reliable than known VCPPP seal technologies. Specifically, the brush seal system 120 may avoid the risk of damage to segment end bristles. Different types of elliptical orientations 175, 215 may be used herein together. Although the brush seal system 120 has been described herein in the context of the rotor 110 of the rotary machine 100, the brush seal system 120 may be applicable between any type of rotating and stationary components so as to limit leakage losses therethrough.

For reason of illustration, it is assumed in the forging descriptions that the critical vibrations are mainly in the vertical direction. In reality, the peak of the vibration vectors may be titled in an angle with vertical direction. The so-called “top” and “bottom” essentially refer to the major axis of the rotor vibration mode. The so-called “side” refers to the minor axis of the rotor vibration mode. The major and minor axes may be in 90 degrees of angle from each other, but not always. Similarly, the top segment is not limited to a top center segment, but rather also includes segments near the top. The same is true for bottom segment.

It should be apparent that the foregoing relates only to certain embodiments of the present application and the resultant patent. Numerous changes and modifications may be made herein by one of ordinary skill in the art without departing from the general spirit and scope of the invention as defined by the following claims and the equivalents thereof

We claim:

1. A brush seal system for use about a rotor of a rotary machine, comprising:
a plurality of brush seal segments;
each of the brush seal segments comprising a plurality of bristles; and
one or more of the plurality of brush seal segments comprising an elliptical profile so as to vary a clearance between the plurality of brush seal segments and the rotor.

2. The brush seal system of claim 1, wherein the elliptical profile comprises a variable length orientation with one or more of the plurality of brush seal segments comprising the plurality of bristles having a shorter length that a remainder of the plurality of brush seal segments.

3. The brush seal system of claim 1, wherein the plurality of brush seal segments comprises one or more first segments with the plurality of bristles of a first length, one or more second segments with the plurality of bristles of a second length, and wherein the first length is less than the second length.

4. The brush seal system of claim 3, wherein the one or more first segments comprise a top segment and/or a bottom segment and the one or more second segments comprise one or more side segments.

5. The brush seal system of claim 1, wherein the plurality of brush seal segments comprises a carrier attached to the plurality of bristles.

6. The brush seal system of claim 5, wherein the carrier comprises a hook thereon.

7. The brush seal system of claim 6, wherein the elliptical profile comprises a contoured orientation with the hook of one or more of the plurality of brush seal segments.

8. The brush seal system of claim 6, wherein the elliptical profile comprises an offset orientation with the one or more hooks comprising an offset diameter.

9. The brush seal system of claim 1, wherein the plurality of brush seal segments comprises a top segment, a bottom segment, a plurality of side segments, and wherein the respective ends of the top segment and the bottom segment are not in contact with the respective ends of the plurality of side segments.

10. The brush seal system of claim 9, wherein the respective ends of a first side segment and a second side segment of the plurality of side segments are in contact.

11. The brush seal system of claim 10, wherein the plurality of brush seal segments are all in contact.

12. The brush seal system of claim 1, wherein the brush seal segments at about a three (3) o'clock position and at about a nine (9) o'clock position on the rotor comprise a first clearance, wherein the brush seal segments at about a twelve (12) o'clock position and at about a six (6) o'clock position comprise a second clearance, and wherein the first clearance is less than the second clearance.

13. The brush seal system of claim 1, wherein the brush seal segments at about a two (2) o'clock position and at about a seven (7) o'clock position on the rotor comprise a first clearance, wherein the brush seal segments at about a four (4) o'clock position and at about a ten (10) o'clock position comprise a second clearance, and wherein the first clearance is less than the second clearance.

14. The brush seal system of claim 1, wherein the elliptical profile comprises a variable length orientation, a contoured orientation, and/or an offset orientation.

15. A brush seal system for use about a rotor of a rotary machine, comprising:
a plurality of brush seal segments;
each of the brush seal segments comprising a plurality of bristles; and
one or more of the plurality of brush seal segments comprising a variable length elliptical orientation so as to vary a clearance between the plurality of brush seal segments and the rotor.

16. The brush seal system of claim 15, wherein the variable length orientation comprises one or more of the plurality of brush seal segments with the plurality of bristles having a shorter length that a remainder of the plurality of brush seal segments.

17. The brush seal system of claim 15, wherein the plurality of brush seal segments comprises one or more first segments with the plurality of bristles of a first length, one or more second segments with the plurality of bristles of a second length, and wherein the first length is less than the second length.

18. The brush seal system of claim 17, wherein the one or more first segments comprise one or more top segments and/or one or more bottom segments and the one or more second segments comprise one or more side segments.

19. A brush seal system for use with a rotor of a rotary machine, comprising:
a plurality of brush seal segments;
each of the brush seal segments comprising a plurality of bristles; and
one or more of the plurality of brush seal segments comprising a contoured elliptical orientation so as to vary a clearance between the plurality of brush seal segments and the rotor.
